(19) United States
(12) Patent Application Publication
(10) Pub. No.: US 2019/0114100 A1
(43) Pub. Date: Apr. 18, 2019

(54) SYSTEM AND METHOD FOR DETECTING HARD DISK STATE

(71) Applicant: HONGFUJIN PRECISION ELECTRONICS (TIANJIN) CO.,LTD., Tianjin (CN)

(72) Inventor: RUI YANG, Tianjin (CN)

(21) Appl. No.: 15/817,062

(22) Filed: Nov. 17, 2017

(30) Foreign Application Priority Data
Oct. 16, 2017 (CN) 201710962953.X

(51) Int. Cl. G06F 3/06; G06F 13/42

(52) U.S. Cl. CPC G06F 3/0629; G06F 3/0689; G06F 13/4282; G06F 3/0653; G06F 3/0619

(57) ABSTRACT

A device for monitoring and detecting respective states of hard disks includes a setting module, a receiving module, and a decoding module. The setting module is configured to set configuration information to one or more SGPIO buses. The receiving module is configured to receive SGPIO signals from the one or more SGPIO buses and an access signal of each hard disk. The decoding module is configured to decode the SGPIO signals according to the configuration information of the SGPIO buses and the access signal of each hard disk to obtain the state information of each hard disk. A hard disk state detecting system and method are also provided.

### FIELD

The subject matter herein generally relates to systems and methods for detecting hard disk state.

### BACKGROUND

A data center comprises a plurality of hard disks for storing data information. The data center monitors an operation of each hard disk to avoid faults in storing data, reading data, or writing data.

### BRIEF DESCRIPTION OF THE DRAWINGS

Implementations of the present technology will now be described, by way of example only, with reference to the attached figures.

FIG. 1 is a block diagram of an embodiment of a hard disk state detecting system.

FIG. 2 is a block diagram of an embodiment of a hard disk state detecting device of FIG. 1.

FIG. 3 is a block diagram of another embodiment of the hard disk state detecting device of FIG. 1.

FIG. 4 is a diagram of an embodiment of a display interface of a display module for displaying waveforms of SGPIO signals and a hard disk state table in the system of FIG. 1.

FIG. 5 is a flowchart of an embodiment of a hard disk state detecting method of the hard disk state detecting device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

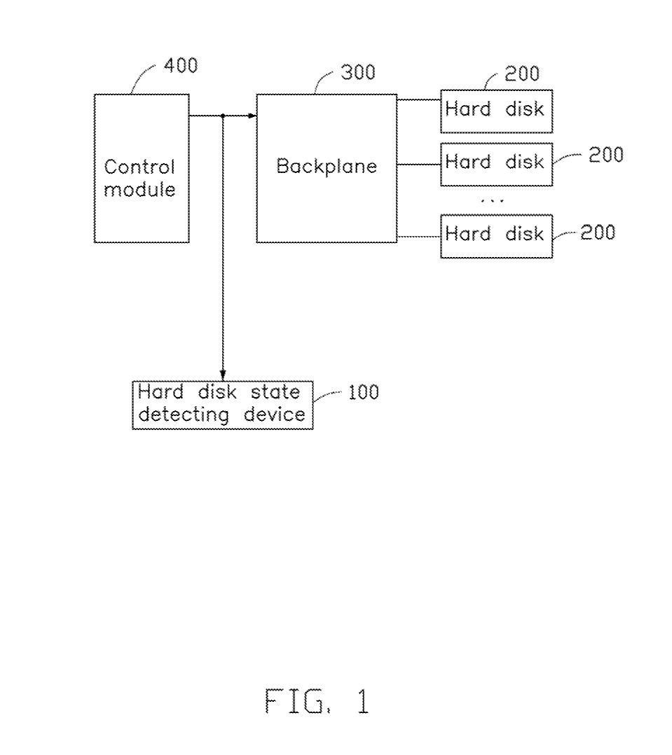

FIG. 1 illustrates a hard disk state detecting system 1 in accordance with an embodiment.

The hard disk state detecting system 1 comprises a hard disk state detecting device 100, a plurality of hard disks 200, a backplane 300, and a control module 400. The hard disk state detecting device 100 is configured to monitor the plurality of hard disks 200 and obtain information as to the state of each hard disk 200. The plurality of hard disks 200 can be plugged to the backplane 300. The control module 400 may communicate with the plurality of hard disks 200 through the backplane 300.

In one embodiment, the control module 400 may manage the plurality of hard disks 200 through one or more serial general purpose input/output (SGPIO) buses. A number of the SGPIO buses is determined by a number of the hard disks 200. SGPIO signals transmitted by the SGPIO buses comprise serial numbers of the hard disks 200 and the state information of the hard disks 200.

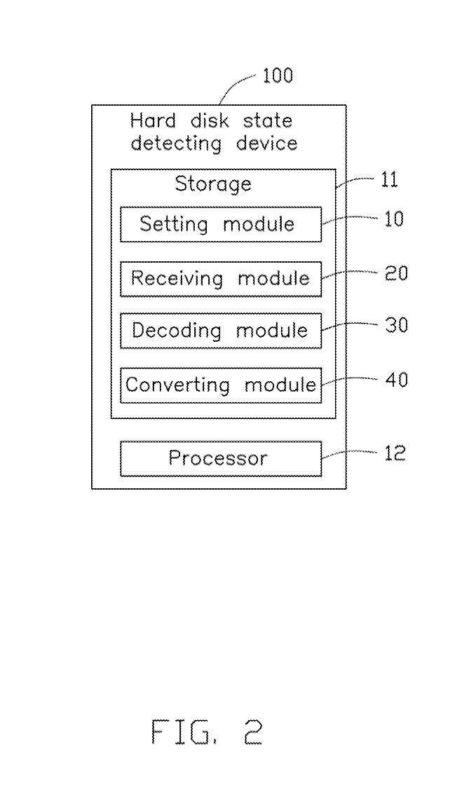

Referring to FIG. 2, the hard disk state detecting device 100 may comprise at least one storage 11 and at least one processor 12. The hard disk state detecting device 100 may further comprise a plurality of modules, such as a setting module 10, a receiving module 20, a decoding module 30, and a converting module 40. The modules 10-40 may comprise one or more software programs in the form of computerized codes stored in the storage 11. The computerized codes may include instructions that can be executed by the processor 12 to provide functions for the modules 10-40.

The setting module 10 is configured to set configuration information to the one or more SGPIO buses.

In one embodiment, the control module 400 may comprise one or more types of controllers. The setting module 10 sets the configuration information to each SGPIO bus according to a clock signal of each controller. The control module 400 may comprise a platform controller hub (PCH) chip and a host bus adapter (HBA) chip for example. The SGPIO signals outputted by the PCH chip and the HBA chip comprise different clock frequencies. For example, the PCH chip may output a first SGPIO signal having a first clock frequency through a first SGPIO bus. The HBA chip may output a second SGPIO signal having a second clock frequency through a second SGPIO bus. When the SGPIO signals outputted by the first SGPIO bus and the second SGPIO bus have different clock frequencies, the setting module 10 sets the configuration information to the first SGPIO bus and the second first SGPIO bus to perform decoding of the SGPIO signals.

The receiving module 20 is configured to receive the SGPIO signals from the one or more SGPIO buses and an access signal of each hard disk 200.

In one embodiment, the backplane 300 comprises a plurality of detecting pins HDD_PRSNT to determine whether the plurality of hard disk 200 is plugged to the backplane 300. For example, when a first hard disk 200 is plugged into the backplane 300, a first detecting pins HDD_PRSNT may output a first access signal. When the first hard disk 200 is not plugged into the backplane 300, the first detecting pins HDD_PRSNT does not output the first access signal.

The decoding module 30 is configured to decode the SGPIO signals according to the configuration information of the SGPIO buses and the access signal of each hard disk 200 to obtain information as to the state of each hard disk 200.

In one embodiment, the decoding module 30 may match the SGPIO signals with the configuration information and select a correct configuration information to decode each SGPIO signal.

In one embodiment, the state information of each hard disk 200 may be defined to indicate two conditions. A first condition is that the hard disk 200 is plugged to the backplane 300 and a second condition is that the hard disk 200 is not plugged to the backplane 300. The first condition may comprise five states. The first state is defined as “no activity” state, the second state is defined as “fail” state, the third state is defined as “locate” state, the fourth state is defined as “rebuild” state, and the fifth state is defined as “activity” state. The second condition may comprise one state, this state is defined as “not present” state.

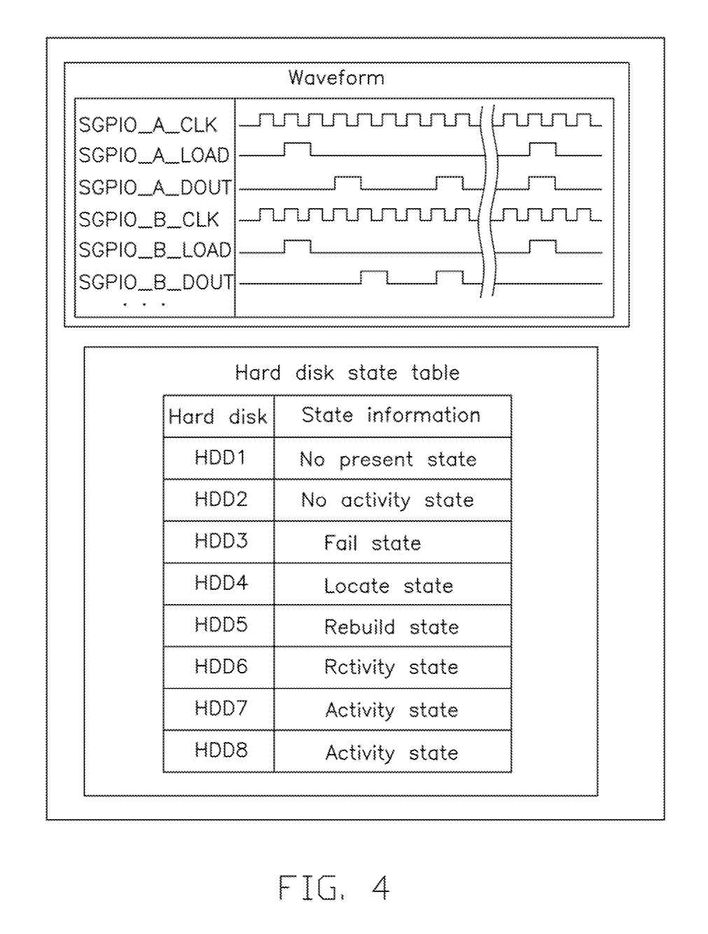

The converting module 40 is configured to measure signal levels of the SGPIO signals and convert the SGPIO signals to digital signals (analog-digital conversion) to display waveforms of the SGPIO signals (as shown in FIG. 4). For example, when a signal level of a first SGPIO signal is greater than 2.5V, the converting module 40 converts the first SGPIO signal to a logic-high signal (logic “1”). When a signal level of the first SGPIO signal is less than 0.7V, the converting module 40 converts the first SGPIO signal to a logic-low signal (logic “0”).

In one embodiment, the setting module 10 is further configured to set a total number of the hard disks 200. The decoding module is further configured to decode the SGPIO signals according to the configuration information of the SGPIO buses, the total number of the hard disks 200, and the access signal of each hard disk 200 to obtain the state information of each hard disk 200.

In one embodiment, the setting module 10 is further configured to assign a unique number to each hard disk 200. The decoding module is further configured to generate a hard disk state table (as shown in FIG. 4) according to the unique number of each hard disk 200 and the state information of each hard disk 200.

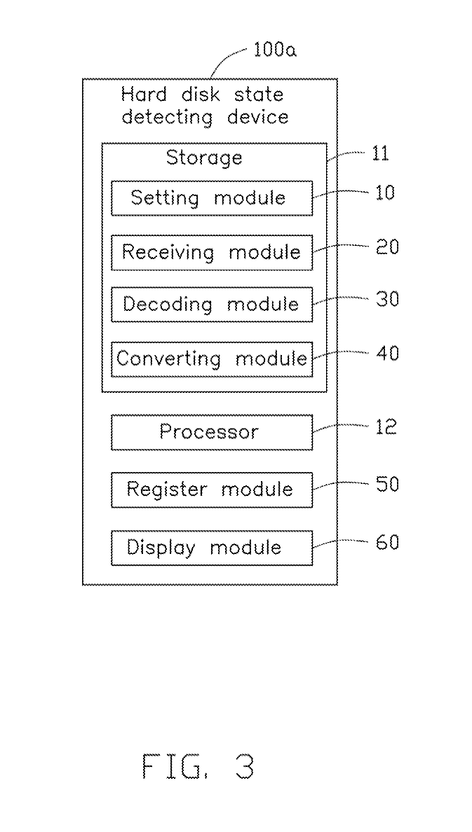

FIG. 3 illustrates a hard disk state detecting device 100a in accordance with an embodiment. The hard disk state detecting device 100a is similar to the hard disk state detecting device 100 of FIG. 2. The difference is that the hard disk state detecting device 100a further comprises a register module 50 and a display module 60. The register module 50 may comprise one or more shift registers. An input terminal of the register module 50 is coupled to the plurality of detecting pins HDD_PRSNT and an output terminal of the register module 50 is coupled to the hard disk state detecting device 100a. Then, the receiving module 20 may receive the access signal of each hard disk 200 through the one or more shift registers.

The display module 60 is configured to display the waveform of the SGPIO signals and the hard disk state table.

Referring to FIG. 4, the waveforms of the SGPIO signals and the hard disk state table are shown on the display module 60. Each SGPIO bus may manage at least one hard disk 200. For example, each SGPIO bus may manage four hard disks 200. When the hard disk state detecting device 100/100a is monitoring eight hard disks 200, the hard disk state detecting device 100/100a may receive and decode the SGPIO signals from two sets of SGPIO buses.

A first set SGPIO bus comprises a first clock pin SGPIO_A_CLK, a first load pin SGPIO_A_LOAD, and a first data pin SGPIO_A_DOUT. A second set SGPIO bus comprises a second clock pin SGPIO_B_CLK, a second load pin SGPIO_B_LOAD, and a second data pin SGPIO_B_DOUT.

For example, the setting module 10 assigns eight numbers, HDD1 to HDD8, to the ten hard disks, respectively. The state information of the hard disk HDD1 is “not present” state, the state information of the hard disk HDD2 is “no activity” state, the state information of the hard disk HDD3 is “fail” state, the state information of the hard disk HDD4 is “locate” state, the state information of the hard disk HDD5 is “rebuild” state. In the remaining disks, the state information of the hard disk HDD6 is “activity” state, the state information of the hard disk HDD7 is “activity” state, the state information of the hard disk HDD8 is “activity” state.

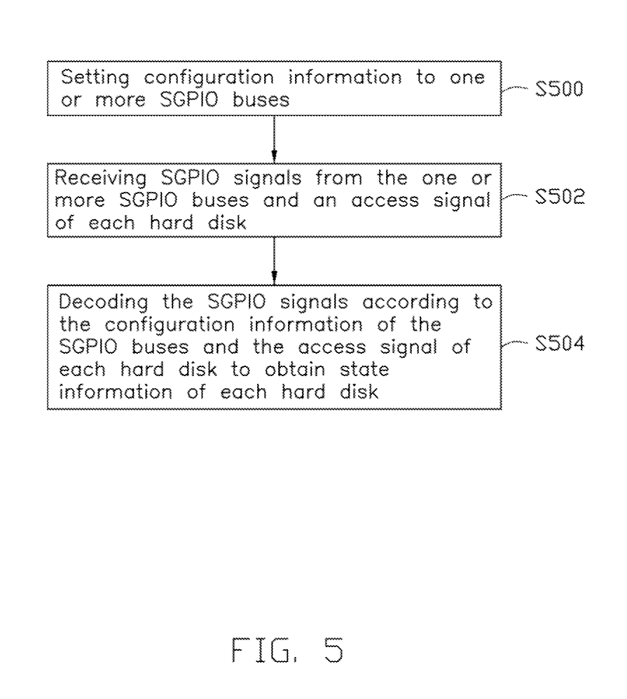

FIG. 5 illustrates one embodiment of a hard disk state detecting method. The flowchart presents an embodiment of the method. The method is provided by way of example, as there are a variety of ways to carry out the method. The method described below can be carried out using the configurations illustrated in FIGS. 1-3, for example, and various elements of these figures are referenced in explaining the example method. Each step shown in FIG. 5 may represent one or more processes, methods, or subroutines, carried out in the example method. Furthermore, the illustrated order of steps is illustrative only and the order of the steps may change. Additional steps may be added or fewer steps may be utilized, without departing from this disclosure. The example method may begin at step 500.

In step 500, the setting module 10 sets configuration information to the one or more SGPIO buses.

In step 502, the receiving module 20 receives SGPIO signals from the one or more SGPIO buses and an access signal of each hard disk 200.

In step 504, the decoding module 30 decodes the SGPIO signals according to the configuration information of the SGPIO buses and the access signal of each hard disk 200, to obtain the state information of each hard disk 200.

The embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A hard disk state detecting method for monitoring a plurality of hard disks, the hard disk state detecting method comprising:
setting configuration information to one or more serial general purpose input/output (SGPIO) buses;
receiving SGPIO signals from the one or more SGPIO buses and an access signal of each hard disk; and
decoding the SGPIO signals according to the configuration information of the SGPIO buses and the access signal of each hard disk to obtain state information of each hard disk.

2. The hard disk state detecting method of claim 1, wherein decoding the SGPIO signals according to the configuration information of the SGPIO buses and the access signal of each hard disk to obtain the state information of each hard disk comprises:
setting a total number of the plurality of hard disks; and
decoding the SGPIO signals according to the configuration information of the SGPIO buses, the total number of the hard disks, and the access signal of each hard disk to obtain the state information of each hard disk.

3. The hard disk state detecting method of claim 1, wherein receiving the access signal of each hard disk comprises:
receiving the access signal of each hard disk through a shift register.

4. The hard disk state detecting method of claim 1, wherein setting the configuration information to the one or more SGPIO buses comprises:
setting the configuration information to each SGPIO bus according to a clock signal of a corresponding controller;
wherein the controller comprises at least one SGPIO bus to output the SGPIO signals.

5. The hard disk state detecting method of claim 1, further comprising:
measuring signal levels of the SGPIO signals and converting the SGPIO signals to digital signals to display waveforms of the SGPIO signals.

6. The hard disk state detecting method of claim 1, further comprising:
assigning a unique number to each hard disk; and
generating a hard disk state table according to the unique number of each hard disk and the state information of each hard disk.

7. The hard disk state detecting method of claim 1, wherein the SGPIO buses comprise at least two types of configuration information.

8. A hard disk state detecting device for monitoring a plurality of hard disks, the hard disk state detecting device comprising:
at least one processor;
a storage; and
one or more programs that are stored in the storage unit and executed by the at least one processor, the one or more programs comprising instructions for:
setting configuration information to one or more SGPIO buses;
receiving SGPIO signals from the one or more SGPIO buses and an access signal of each hard disk; and
decoding the SGPIO signals according to the configuration information of the SGPIO buses and the access signal of each hard disk to obtain state information of each hard disk.

9. The hard disk state detecting device of claim 8, wherein decoding the SGPIO signals according to the configuration information of the SGPIO buses and the access signal of each hard disk to obtain the state information of each hard disk comprises:
setting a total number of the plurality of hard disks; and
decoding the SGPIO signals according to the configuration information of the SGPIO buses, the total number of the hard disks, and the access signal of each hard disk to obtain the state information of each hard disk.

10. The hard disk state detecting device of claim 8, wherein receiving the access signal of each hard disk comprises:
receiving the access signal of each hard disk through a shift register.

11. The hard disk state detecting device of claim 8, wherein setting the configuration information to the one or more SGPIO buses comprises:
setting the configuration information to each SGPIO bus according to a clock signal of a corresponding controller;
wherein the controller comprises at least one SGPIO bus to output the SGPIO signals.

12. The hard disk state detecting device of claim 8, wherein the one or more programs further comprise:
measuring signal levels of the SGPIO signals and converting the SGPIO signals to digital signals to display waveforms of the SGPIO signals.

13. The hard disk state detecting device of claim 8, wherein the one or more programs further comprise:
assigning a unique number to each hard disk; and
generating a hard disk state table according to the unique number of each hard disk and the state information of each hard disk.

14. The hard disk state detecting device of claim 8, wherein the SGPIO buses comprise at least two types of configuration information.

15. A hard disk state detecting system comprising:
a plurality of hard disks;
a control module configured to communicate with the plurality of hard disks through one or more SGPIO buses; and
a hard disk state detecting device, comprising:
at least one processor;
a storage; and
one or more programs that are stored in the storage unit and executed by the at least one processor, the one or more programs comprising instructions for:
setting configuration information to the one or more SGPIO buses;
receiving SGPIO signals from the one or more SGPIO buses and an access signal of each hard disk; and
decoding the SGPIO signals according to the configuration information of the SGPIO buses and the access signal of each hard disk to obtain state information of each hard disk.

16. The hard disk state detecting system of claim 15, wherein decoding the SGPIO signals according to the configuration information of the SGPIO buses and the access signal of each hard disk to obtain the state information of each hard disk comprises:
setting a total number of the plurality of hard disks; and
decoding the SGPIO signals according to the configuration information of the SGPIO buses, the total number of the hard disks, and the access signal of each hard disk to obtain the state information of each hard disk.

17. The hard disk state detecting system of claim 15, wherein receiving the access signal of each hard disk comprises:
receiving the access signal of each hard disk through a shift register.

18. The hard disk state detecting system of claim 15, wherein setting the configuration information to the one or more SGPIO buses comprises:
setting the configuration information to each SGPIO bus according to a clock signal of a corresponding controller;
wherein the controller comprises at least one SGPIO bus to output the SGPIO signals.

19. The hard disk state detecting system of claim 15, wherein the one or more programs further comprise:
measuring signal levels of the SGPIO signals and converting the SGPIO signals to digital signals to display waveforms of the SGPIO signals.

20. The hard disk state detecting system of claim 15, wherein the SGPIO buses comprise at least two types of configuration information.
